(19) United States
(12) Patent Application Publication
(10) Pub. No.: US 2015/0358172 A1
(43) Pub. Date: Dec. 10, 2015

(54) EQUIPMENT INFORMATION MANAGEMENT DEVICE, EQUIPMENT INFORMATION MANAGEMENT SYSTEM, AND EQUIPMENT INFORMATION MANAGEMENT METHOD

(71) Applicant: Tsutomu KINOMOTO, Kanagawa (JP)

(72) Inventor: Tsutomu KINOMOTO, Kanagawa (JP)

(73) Assignee: RICOH COMPANY, LTD., Tokyo (JP)

(21) Appl. No.: 14/681,289

(22) Filed: Apr. 8, 2015

(30) Foreign Application Priority Data
Jun. 6, 2014 (JP) 2014-117297

(51) Int. Cl. H04L 12/18; H04L 12/14; G06Q 10/10; G06Q 10/08

(52) U.S. Cl. CPC H04L 12/1831; G06Q 10/087; H04L 12/141; G06Q 10/109; H04L 12/1881

(57) ABSTRACT

An equipment information management device is for managing information relating to equipment that is a management target. The equipment information management device includes a calculating unit configured to calculate a usage result value that indicates usage of used equipment, based on usage information relating to the used equipment among the equipment that is the management target; a collecting unit configured to collect information of equipment relating to the used equipment; and an output unit configured to output report information including the calculated usage result value and the collected information of the relevant equipment.

### BACKGROUND OF THE INVENTION

1. Field of the Invention

The present invention relates to an equipment information management device, an equipment information management system, and an equipment information management method.

2. Description of the Related Art

For example, there is known a conference system for holding a remote conference, with equipment including a conference room, a communication environment, software for conferences, terminal devices, etc., by using a network such as the Internet, WAN (Wide Area Network), etc. Furthermore, in order to suppress the capital-investment spending on an IC card reader, etc. for authentication of a TV conference device, there is known a technology of capturing a two-dimensional code by a camera, and acquiring an identification number of the TV conference and an electronic certificate for certifying an individual participant (see, for example, Patent Document 1).

According to the technology disclosed in Patent Document 1, it is possible to suppress the capital-investment spending per terminal, such as the spending on an authentication IC card reader; however, when a conference, which uses excessive equipment with respect to the scale of the conference, is frequently held, the effect of suppressing the capital-investment spending, etc., is reduced. For example, when a conference with two to three participants is frequently held by using equipment that can be used by 20 people, there is room for reducing the cost by revising the new capital-investment spending or by revising the existing capital-investment spending.

However, by the conventional conference system, etc., it has been difficult to manage as to whether the equipment, etc., used in a conference is efficiently used in accordance with the usage status.

Patent Document 1: Japanese Laid-Open Patent Publication No. 2008-124689

### SUMMARY OF THE INVENTION

The present invention provides an equipment information management device, an equipment information management system, and an equipment information management method, in which one or more of the above-described disadvantages are eliminated.

According to an aspect of the present invention, there is provided an equipment information management device for managing information relating to equipment that is a management target, the equipment information management device including a calculating unit configured to calculate a usage result value that indicates usage of used equipment, based on usage information relating to the used equipment among the equipment that is the management target; a collecting unit configured to collect information of equipment relating to the used equipment; and an output unit configured to output report information including the calculated usage result value and the collected information of the relevant equipment.

According to an aspect of the present invention, there is provided an equipment information management system including an equipment information management device configured to manage information relating to equipment that is a management target; and an external device configured to manage information of a plurality of pieces of equipment including equipment different from the equipment that is the management target, wherein the equipment information management device includes a calculating unit configured to calculate a usage result value that indicates usage of used equipment, based on usage information relating to the used equipment among the equipment that is the management target, a collecting unit configured to collect, from the external device, information of equipment relating to the used equipment, and an output unit configured to output report information including the calculated usage result value and the collected information of the relevant equipment.

According to an aspect of the present invention, there is provided an equipment information management method performed by an equipment information management device for managing information relating to equipment that is a management target, the equipment information management method including calculating a usage result value that indicates usage of used equipment, based on usage information relating to the used equipment among the equipment that is the management target; collecting information of equipment relating to the used equipment; and outputting report information including the calculated usage result value and the collected information of the relevant equipment.

### BRIEF DESCRIPTION OF THE DRAWINGS

Other objects, features and advantages of the present invention will become more apparent from the following detailed description when read in conjunction with the accompanying drawings, in which:

FIG. 1 illustrates a configuration example of an equipment information management system according to an embodiment;

FIG. 2 illustrates an example of a hardware configuration of a computer according to an embodiment;

FIG. 3 illustrates a functional configuration of an equipment information management system according to an embodiment;

FIG. 4 illustrates an example of conference holding information according to an embodiment;

FIG. 5 illustrates an example of attendee information according to an embodiment;

FIG. 6 illustrates an example of conference material information according to an embodiment;

FIG. 7 illustrates an example of conference history information according to an embodiment;

FIG. 8 indicates an example of conference equipment information according to an embodiment;

FIG. 9 illustrates an example of equipment reservation information according to an embodiment;

FIG. 10 illustrates an example of employee management information according to an embodiment;

FIG. 11 illustrates an example of external management information according to an embodiment;

FIG. 12 illustrates an example of accounting management information according to an embodiment;

FIG. 13 illustrates an example of hardware management information according to an embodiment;

FIG. 14 illustrates an example of software management information according to an embodiment;

FIG. 15 illustrates a functional configuration of an equipment information management system according to a first embodiment;

FIG. 16 illustrates an example of conference room management information according to the first embodiment;

FIG. 17 illustrates an example of device management information according to the first embodiment;

FIG. 18 is a sequence chart indicating an example of a process by the equipment information management system according to the first embodiment;

FIG. 19 illustrates a functional configuration of an equipment information management system according to a second embodiment; and

FIG. 20 is a sequence chart indicating an example of a process by the equipment information management system according to the second embodiment.

### DETAILED DESCRIPTION OF THE PREFERRED EMBODIMENTS

A description is given, with reference to the accompanying drawings, of embodiments of the present invention.

### <Configuration of System>

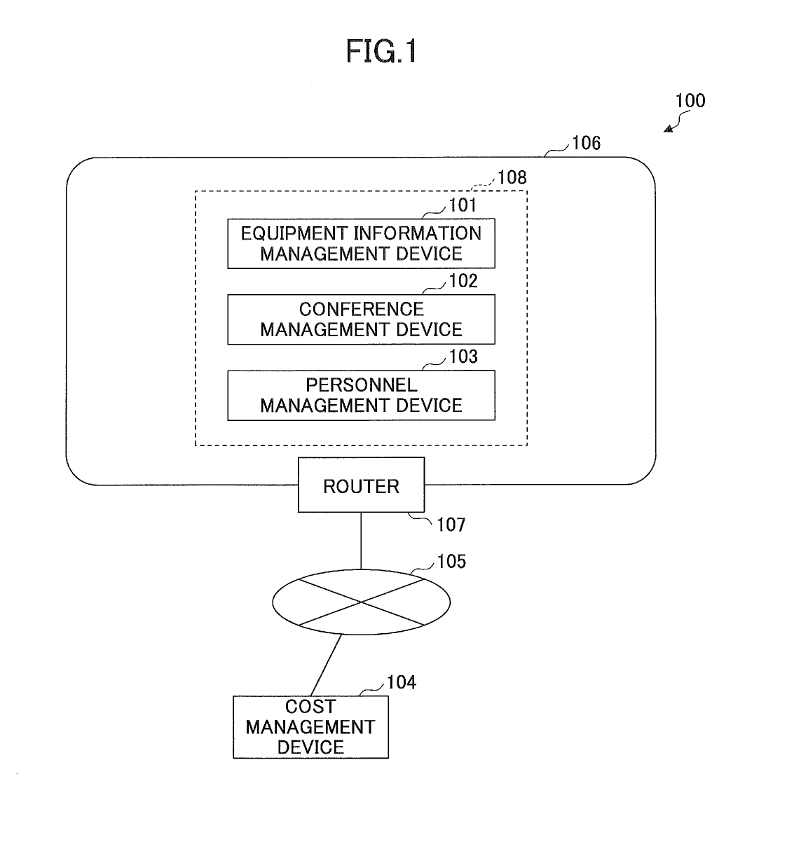

FIG. 1 illustrates a configuration example of an equipment information management system according to an embodiment. An equipment information management system 100 includes, for example, an equipment information management device (equipment information management system) 101, a conference management device (conference management system) 102, a personnel management device (personnel management system) 103, a cost management device (cost management system) 104, etc.

In FIG. 1, the equipment information management device 101, the conference management device 102, and the personnel management device 103 are included in, for example, a customer environment 106 such as an in-house network, etc., and are able to transmit/receive data and information with each other. Furthermore, the cost management device 104 is connected to the customer environment 106, for example, via a network 105 such as WAN (Wide Area Network), etc., and a router 107, etc., and is able to transmit/receive data with the equipment information management device 101, the conference management device 102, and the personnel management device 103.

Note that the configuration of FIG. 1 is merely an example. For example, the equipment information management device 101, the conference management device 102, and the personnel management device 103 may be a single equipment information management device 108, and the conference management device 102 may be included in the equipment information management device 101. Furthermore, the equipment information management system 100 may not necessarily include the conference management device 102. For example, the equipment information management system 100 and the equipment information management device 101 may manage equipment for purposes other than remote conferences, such as equipment for an event, a vehicle, a rental device, an off-line conference, etc.

Furthermore, the network configuration of FIG. 1 is one example. For example, the cost management device 104 may be provided by a server in the Internet, a cloud service, etc. Furthermore, the cost management device 104 may be provided in the customer environment 106, or may be provided in the equipment information management device 101.

In FIG. 1, the equipment information management device 101 manages the equipment that is the target of management, for example, a terminal device used in the remote conference, a device such as a display device, etc., and a conference room, etc. The conference management device 102 manages the hosting procedures of a remote conference, the hosting history, documents distributed, conference minutes, etc. The personnel management device 103 manages information of users of the remote conference, for example, employee information, etc., and costs spent on hosting the conference, etc. The cost management device 104 manages information relevant to hardware (devices) and software, etc., needed for the remote conference.

In the present embodiment, the equipment information management device 101 creates and outputs a report including the usage result value (for example, the cost) according to the usage of the equipment that has been used (used equipment), and the equipment relevant to the used equipment (for example, alternative equipment, etc.), based on the usage information of the equipment used within a predetermined period. Preferably, the equipment information management device 101 creates a report including the breakdown of the usage cost of equipment used within a predetermined period, etc., and the breakdown of the usage cost of alternative equipment according to the usage information of the equipment, and sends the report to a user (for example, the administrator, the conference host, etc.).

Accordingly, it is easy for the user to manage as to whether the equipment used in a remote conference, etc., is efficiently used in accordance with the usage status (for example, the number of users, etc.).

### <Hardware Configuration>

Next, a description is given of a hardware configuration of the devices. The equipment information management device 101, the conference management device 102, the personnel management device 103, and the cost management device 104 have a configuration of, for example, a general-purpose computer.

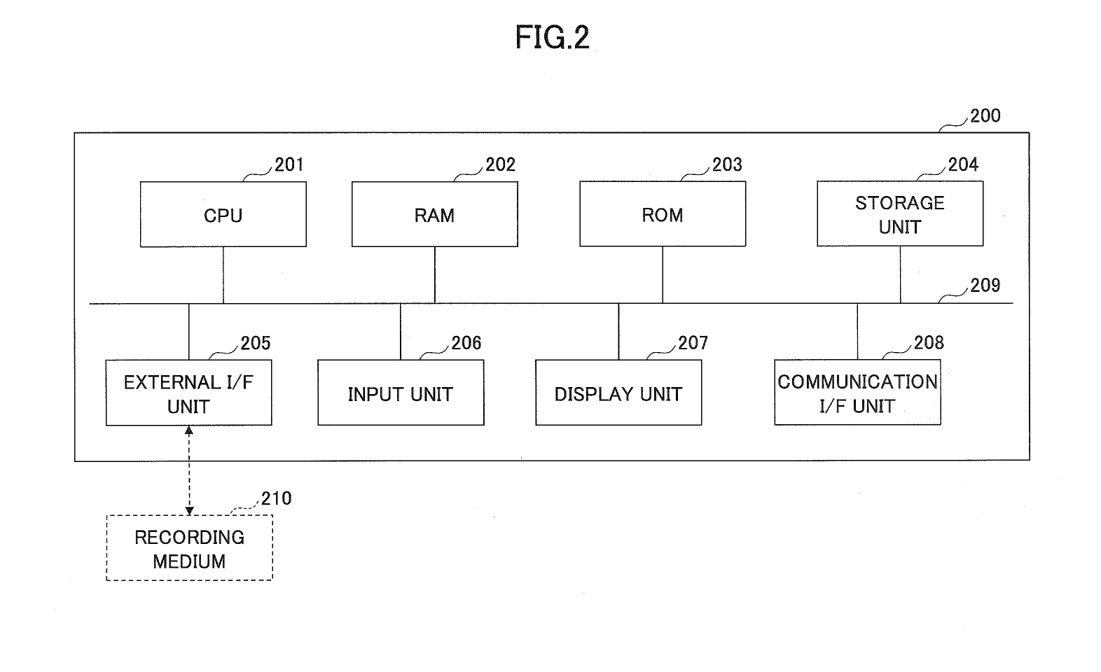

FIG. 2 illustrates an example of a hardware configuration of a computer that can be used as the equipment information management device 101, the conference management device 102, the personnel management device 103, the cost management device 104, etc. A computer 200 includes, for example, a CPU (Central Processing Unit) 201, a RAM (Random Access Memory) 202, a ROM (Read-Only Memory) 203, a storage unit 204, an external I/F (interface) unit 205, an input unit 206, a display unit 207, a communication I/F unit 208, a bus 209, etc.

The CPU 201 is a processor for realizing the functions of the computer 200, by loading the programs and data stored in the ROM 203, the storage unit 204, etc., into the RAM 202, and executing processes. The RAM 202 is a volatile memory used as a work area, etc., of the CPU 201. The ROM 203 is a non-volatile memory that stores programs and data even after the power is turned off, and is constituted by, for example, a flash ROM, etc.

The storage unit 204 is, for example, a storage device such as a HDD (Hard Disk Drive), a SSD (Solid State Drive), etc., and stores an OS (Operation System), application programs, various kinds of data, etc.

The external I/F unit 205 is an interface between the computer 200 and an external recording medium 210, etc. The computer 200 is able to read data from and/or write date in the recording medium 210 via the external I/F unit 205. As the recording medium 210, for example, an optical disk, a magnetic disk, a memory card, a USB (Universal Serial Bus) memory, etc., are included. Furthermore, it is possible to execute a predetermined program by storing the predetermined program in the recording medium 210, and installing the program stored in the recording medium 210 into the computer 200 via the external I/F unit 205.

The input unit 206 includes a pointing device such as a mouse, etc., and a keyboard, etc., and is used for inputting various operation signals in the computer 200. The display unit 207 includes a display, etc., and displays processing results, etc., obtained by the computer 200.

The communication I/F unit 208 is an interface that connects the computer 200 to the network. By the communication I/F unit 208, the computer 200 is able to perform data communication with other devices via the network. The bus 209 is connected to the respective elements described above, and transmits address signals, data signals, various control signals, etc.

Note that the configuration of FIG. 2 is merely one example. For example, the computer 200 may have the input unit 206, the display unit 207, etc., provided externally, or the computer 200 does not necessarily need to include the input unit 206 or the display unit 207. Furthermore, the equipment information management device 101, the conference management device 102, the personnel management device 103, and the cost management device 104 may be respectively constituted by combinations of a plurality of computers 200, etc. Furthermore, the equipment information management device 101, the conference management device 102, the personnel management device 103, and the cost management device 104 may be realized by a device having a configuration of a general-purpose computer, for example, an image forming apparatus, etc.

### <Functional Configuration>

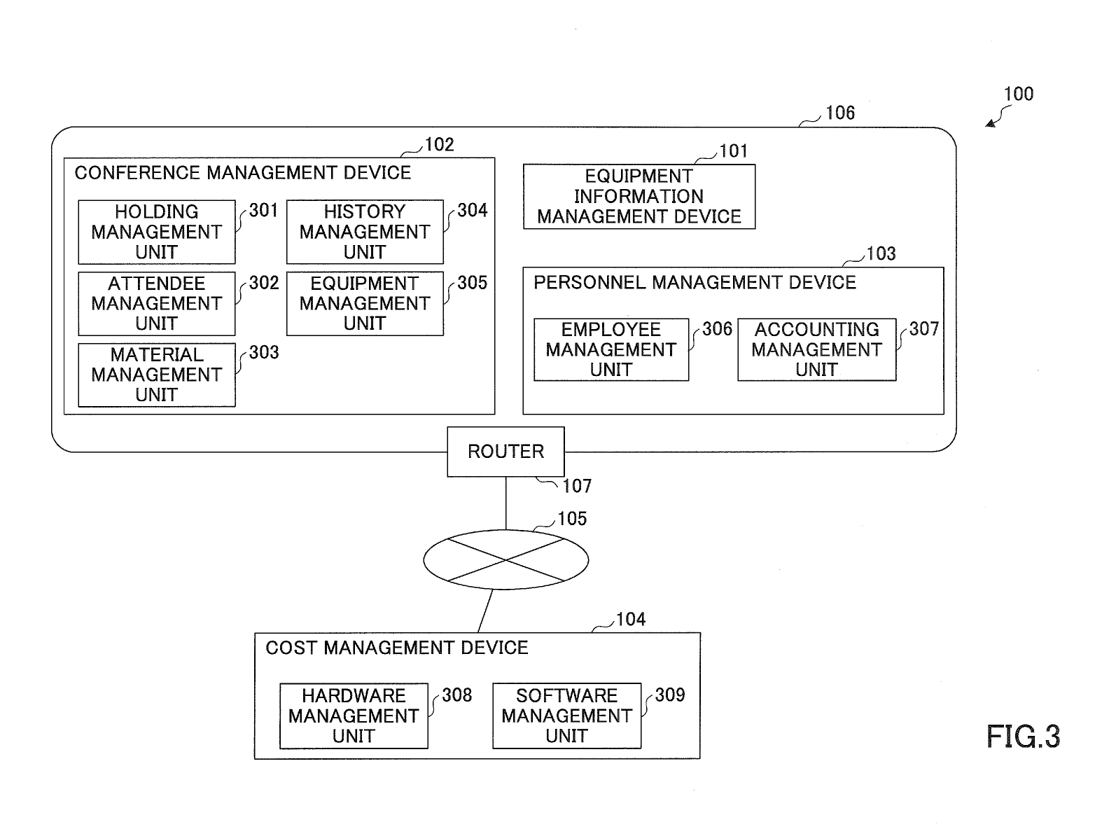

FIG. 3 illustrates a functional configuration of an equipment information management system according to an embodiment.

(Functional Configuration of Conference Management Device)

The conference management device 102 manages various kinds of information relevant to the conference. For example, the conference management device 102 includes a holding management unit 301, an attendee management unit 302, a material management unit 303, a history management unit 304, an equipment management unit 305, etc. Note that the holding management unit 301, the attendee management unit 302, the material management unit 303, the history management unit 304, and the equipment management unit 305 are realized by, for example, programs, etc., operating in the CPU 201, etc., in FIG. 2.

The holding management unit 301 manages information, etc., relevant to holding a conference such as a remote conference, etc. For example, the holding management unit 301 receives a reservation operation, etc., for a conference by the host of the conference, and manages the registered information, etc., as conference holding information.

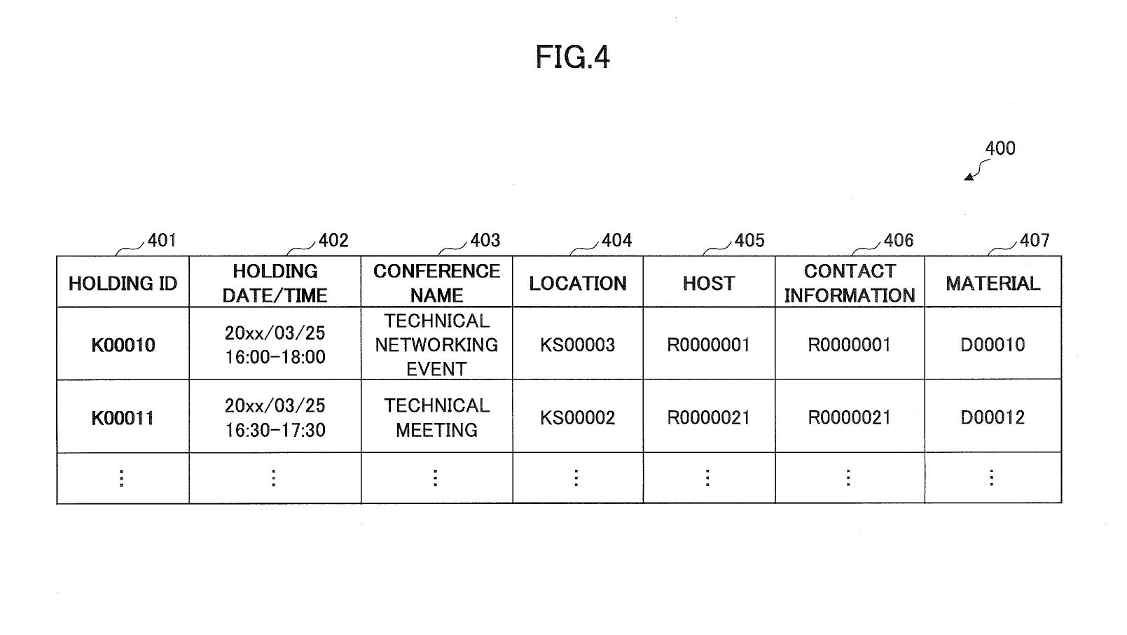

FIG. 4 illustrates an example of conference holding information according to an embodiment. Conference holding information 400 includes, for example, information items of a holding ID 401, a holding date/time 402, a conference name 403, a location 404, a host 405, contact information 406, a material 407, etc.

The holding ID 401 is an identifier (identification information) for identifying a conference. The holding date/time 402 is information indicating the date and time, etc., when the conference is held. The conference name 403 is a name applied to the conference. The location 404 is information indicating the location (for example, the conference room, etc.) where the conference is held, and is managed by, for example, a conference ID, etc., managed by the equipment information management device 101.

The host 405 is information indicating the host, the person in charge of the conference, etc.; for example, the host 405 is managed by an employee ID, etc., managed by an employee management unit 306 of the personnel management device 103. The contact information 406 is information indicating the contact relevant to the conference; for example, the contact information 406 is managed by an employee ID, etc., managed by an employee management unit 306 of the personnel management device 103. The material 407 is information such as documents distributed, etc., used in the conference, and is managed by, for example, a material ID, etc., managed by the material management unit 303.

The attendee management unit 302 of FIG. 3 manages attendee information including information relevant to the attendees of the conference.

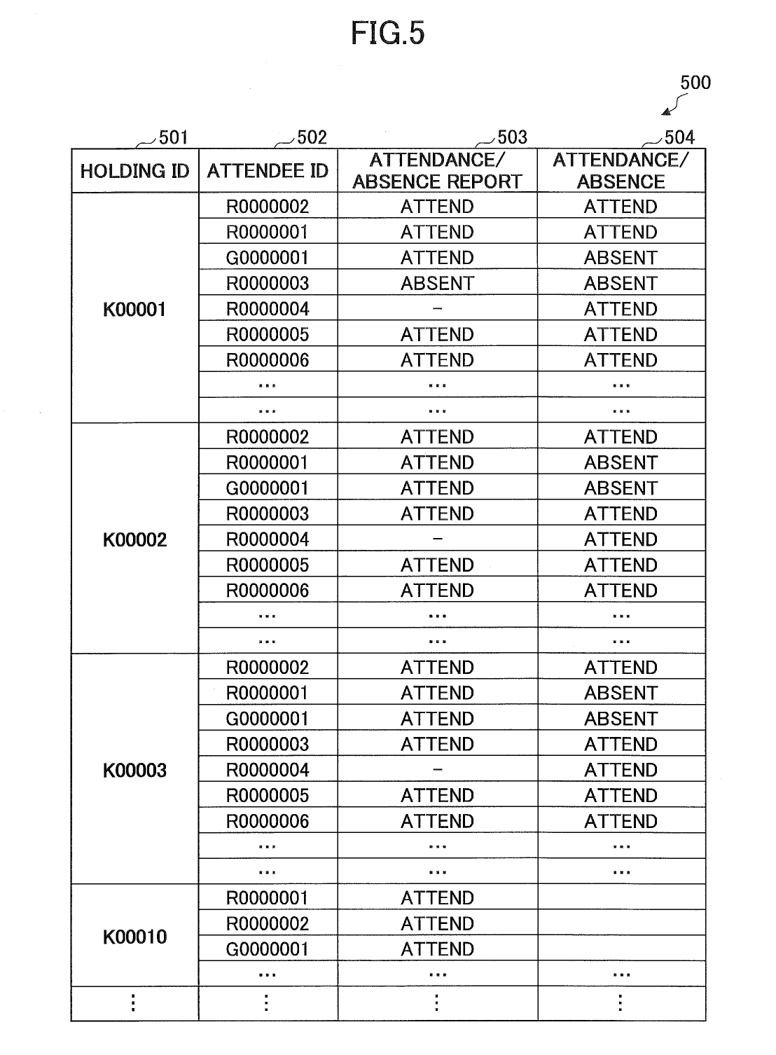

FIG. 5 illustrates an example of attendee information according to an embodiment. Attendee information 500 includes information items of a holding ID 501, an attendee ID 502, attendance/absence report 503, attendance/absence 504, etc.

The holding ID 501 is an identifier for identifying a conference, and is managed by, for example, the holding ID 401, etc., managed by the holding management unit 301. The attendee ID 502 is information indicating an attendee participating in the conference, and is managed by, for example, an employee ID, etc., managed by the employee management unit 306 of the personnel management device 103. In the attendance/absence report 503, information of the participation/absence, etc., of each participant is recorded, before the conference is held. In the attendance/absence 504 is information of the participation/absence, etc., of each participant is recorded, when the conference is held, etc.

The material management unit 303 of FIG. 3 manages materials of the conference registered by the host, the participant, etc., of the conference, and conference material information including information relevant to the conference minutes, etc.

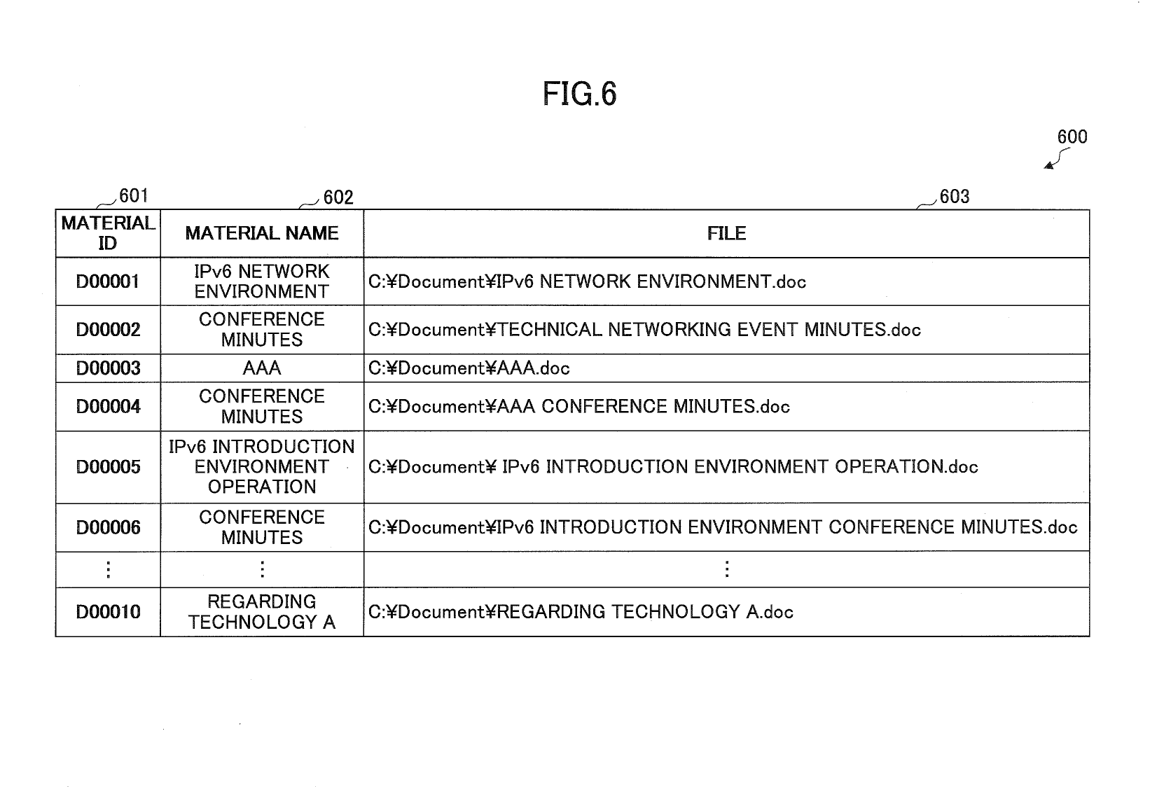

FIG. 6 illustrates an example of conference material information according to an embodiment. Conference material information 600 includes, for example, information items of a material ID 601, a material name 602, a file 603, etc. The material ID 601 is an identifier for identifying a material of the conference. The material name 602 is a name, etc., relevant to the material. The file 603 is information of a file in which the material is stored. For example, a participant of the conference is able to obtain a material used in the conference, based on this conference material information 600.

The history management unit 304 in FIG. 3 manages conference history information including information of the holding history, etc., of a conference that has been held.

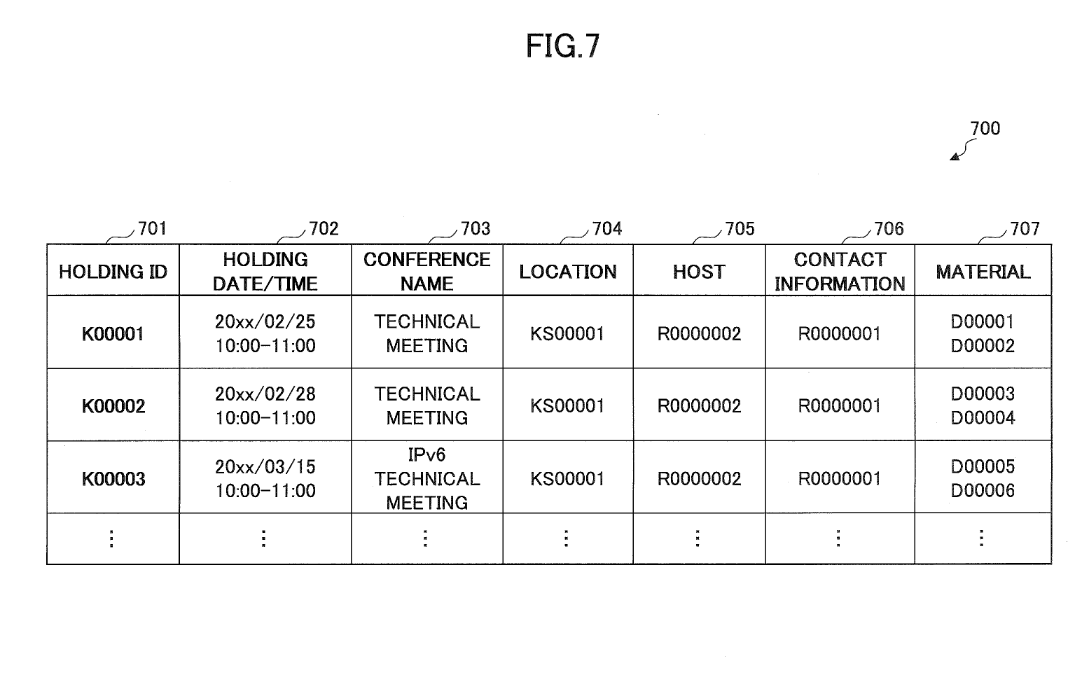

FIG. 7 illustrates an example of conference history information according to an embodiment. Conference history information 700 includes information items of a holding ID 701, a holding date/time 702, a conference name 703, a location 704, a host 705, contact information 706, a material 707, etc.

The holding ID 701 is an identifier for identifying the conference, and corresponds to, for example, the holding ID 401 managed by the holding management unit 301. The holding date/time 702 is information indicating the date and time, etc., when the conference is held, and corresponds to, for example, the holding date/time 402 managed by the holding management unit 301. The conference name 703 is a name applied to the conference, and corresponds to, for example, the conference name 403 managed by the holding management unit 301. The location 704 is information indicating the location (for example, the conference room, etc.) where the conference is held, and corresponds to, for example, the location 404 managed by the holding management unit 301.

The host 705 is information indicating the host, the person in charge of the conference, etc., and corresponds to, for example, the host 405 managed by the holding management unit 301. The contact information 706 is information indicating the contact relevant to the conference, and corresponds to, for example, the contact information 406 managed by the holding management unit 301. The material 707 is information of a document distributed, etc., used in a conference, and corresponds to, for example, the material 407 managed by the holding management unit 301.

The equipment management unit 305 of FIG. 3 manages conference equipment information including information of equipment, etc., used in the conference, and equipment reservation information including information relevant to the reservation of equipment of the conference, etc.

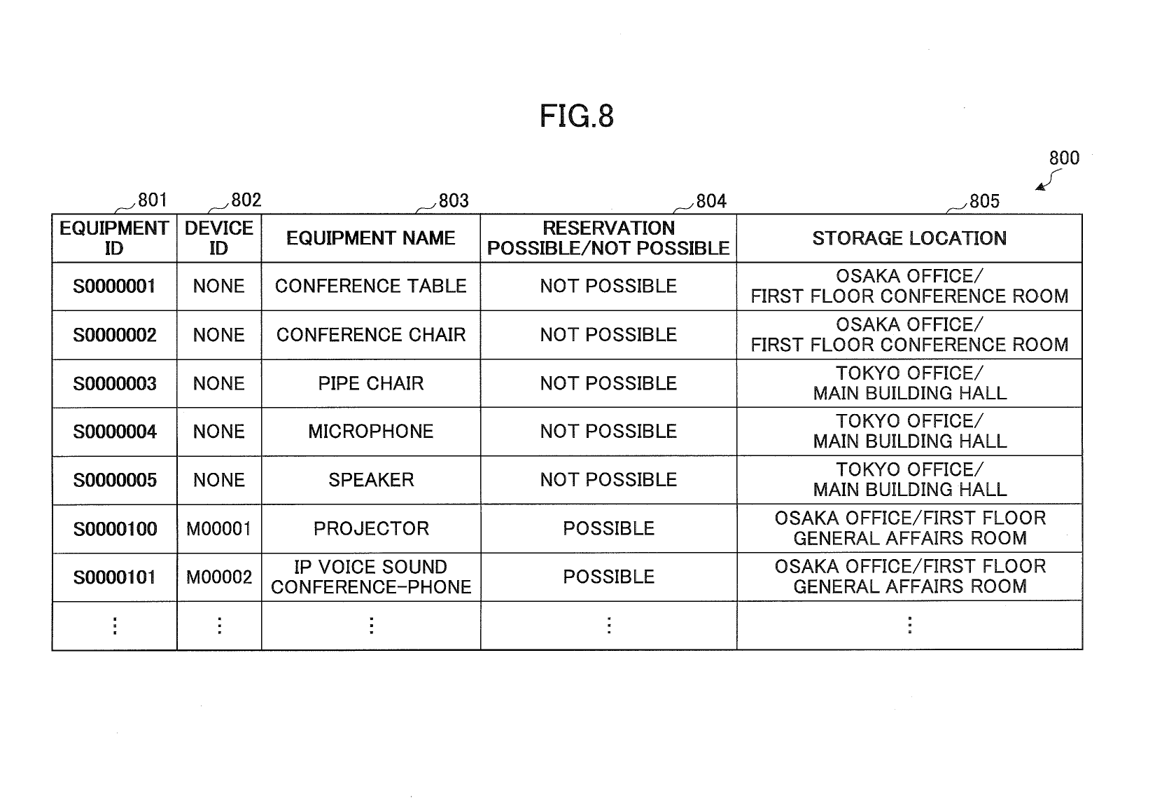

FIG. 8 indicates an example of conference equipment information according to an embodiment. Conference equipment information 800 includes information items of, for example, an equipment ID 801, a device ID 802, an equipment name 803, reservation possible/not possible 804, a storage location 805, etc.

The equipment ID 801 is an identifier for identifying equipment. The device ID 802 is an identifier for identifying a device, when the equipment is a device; for example, the device ID 802 is expressed by a device ID managed by the equipment information management device 101, etc. The equipment name 803 is a name, etc., applied to the equipment. The reservation possible/not possible 804 is information indicating whether the equipment can be reserved. The storage location 805 is information indicating the location where the equipment is stored.

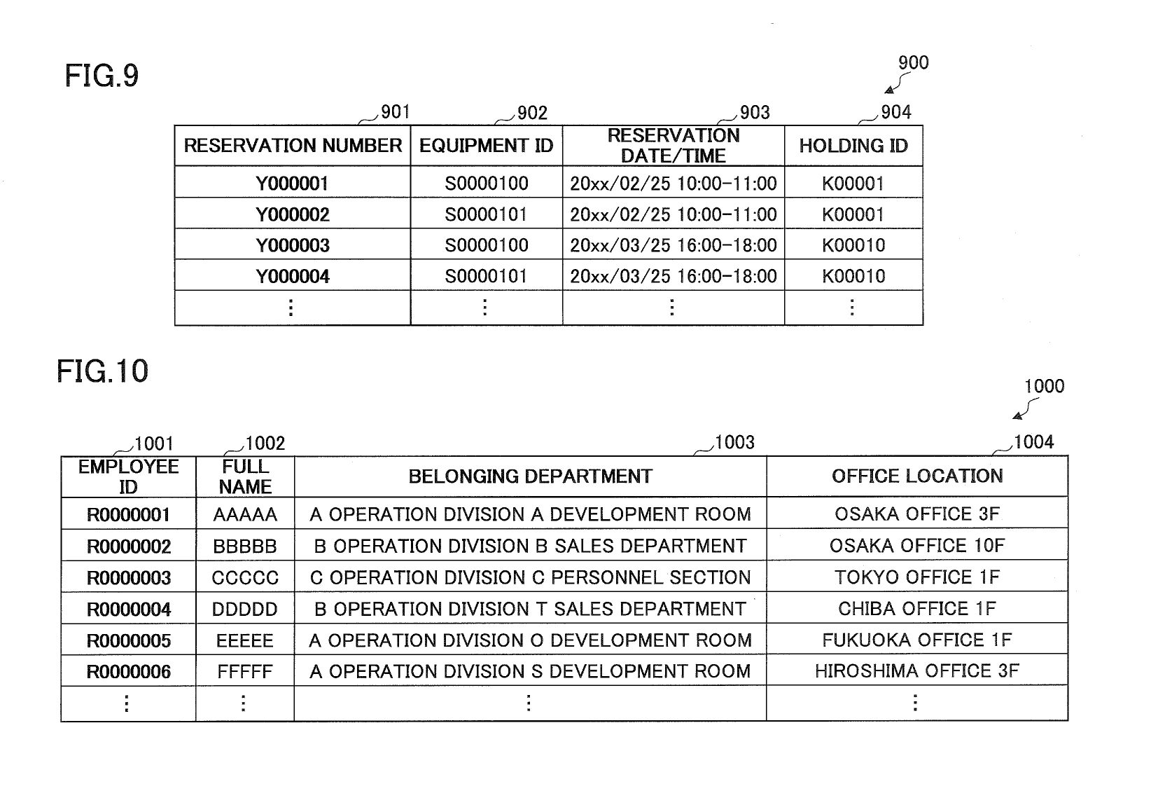

FIG. 9 illustrates an example of equipment reservation information according to an embodiment. Equipment reservation information 900 includes information items of, for example, a reservation number 901, an equipment ID 902, a reservation date/time 903, a holding ID 904, etc.

The reservation number 901 is an identifier for identifying the reservation of equipment. The equipment ID 902 is an identifier for identifying equipment, and corresponds to, for example, the equipment ID 801 of FIG. 8. The reservation date/time 903 is information indicating the date and time, etc., on which the equipment is reserved. The holding ID 904 is an identifier for identifying a conference, and corresponds to, for example, the holding ID 401 of FIG. 4.

As described above, the conference management device 102 manages various kinds of information relevant to the conference, as illustrated FIGS. 4 through 9.

(Functional Configuration of Personnel Management Device)

The personnel management device 103 of FIG. 3 manages various kinds of information relevant to personnel and accounting. For example, the personnel management device 103 includes an employee management unit 306, an accounting management unit 307, etc. Note that the employee management unit 306 and the accounting management unit 307 are realized by, for example, programs, etc., operating in the CPU 201, etc., of FIG. 2.

The employee management unit 306 manages, for example, employee management information that is information relevant to employees of a client company, etc., and external management information that is information relevant to and external personnel other than employees (for example, visitors from outside the company, employees of a subcontracting company, etc.), etc.

FIG. 10 illustrates an example of employee management information according to an embodiment. Employee management information 1000 includes information items of an employee ID 1001, a full name 1002, a belonging department 1003, an office location 1004, etc. The employee ID 1001 is an identifier for identifying an employee. The full name 1002 is information of the full name, etc., of the employee. The belonging department 1003 is information of a department, etc., to which the employee belongs. The office location 1004 is information indicating the location of the employee, for example, a place where the seat of the employee is located, etc.

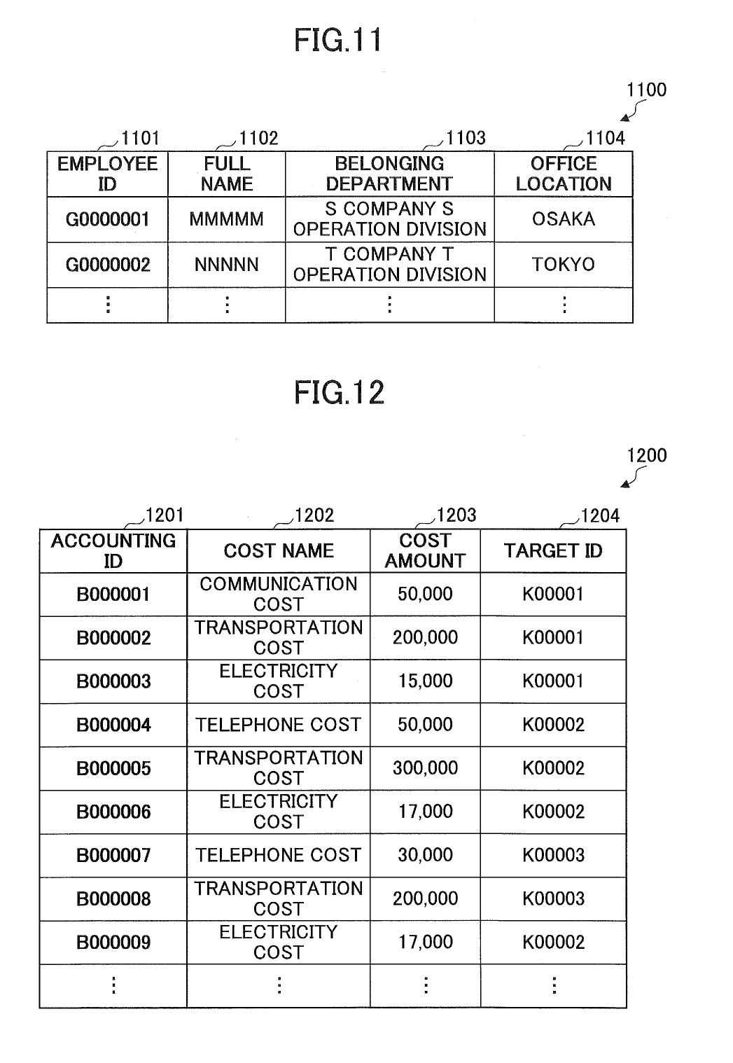

FIG. 11 illustrates an example of external management information according to an embodiment. External management information 1100 includes information items of, for example, an employee ID 1101, a full name 1102, a belonging department 1103, an office location 1104, etc.

The employee ID 1101 is an identifier for identifying an external staff. In the example of FIG. 11, an identifier similar to that of the employee ID 1001 of FIG. 10 is used, except that the first letter is set as “G”, to manage this as an identifier of an external staff. Note that the employee ID 1101 may be managed as information other than the employee ID, such as an external staff ID.

The full name 1102 is the full name of the external staff. The belonging department 1103 is information of the name of the company, the department, etc., to which the external staff belongs. The office location 1104 is, for example, information of the location, etc., of the department to which the external staff belongs.

The accounting management unit 307 of FIG. 3 manages accounting management information including information of the cost, etc., spent for holding the conference.

FIG. 11 illustrates an example of accounting management information according to an embodiment. Accounting management information 1200 includes information items of, for example, an accounting ID 1201, a cost name 1202, a cost amount 1203, a target ID 1204, etc. The accounting ID 1201 is an identifier for identifying accounting information. The cost name 1202 is information indicating a name, etc., of accounting information. The cost amount 1203 is information indicating the cost, etc., spent in each accounting information item. The target ID 1204 is an identifier that is the target of the accounting information, and in the present embodiment, the target ID 1204 corresponds to the holding ID 701, etc., of FIG. 7.

As described above, the personnel management device 103 manages various kinds of information relevant to personnel and accounting, as illustrated FIGS. 10 through 12.

(Functional Configuration of Cost Management Device)

The cost management device 104 of FIG. 3 manages various kinds of information including information of the cost relevant to hardware and software used in a conference. For example, the cost management device 104 includes a hardware management unit 308, a software management unit 309, etc. Note that the hardware management unit 308 and the software management unit 309 are realized by, for example, programs, etc., operating in the CPU 201, etc., of FIG. 2.

The hardware management unit 308 manages information of the hardware (devices) used in a conference, etc., as hardware management information.

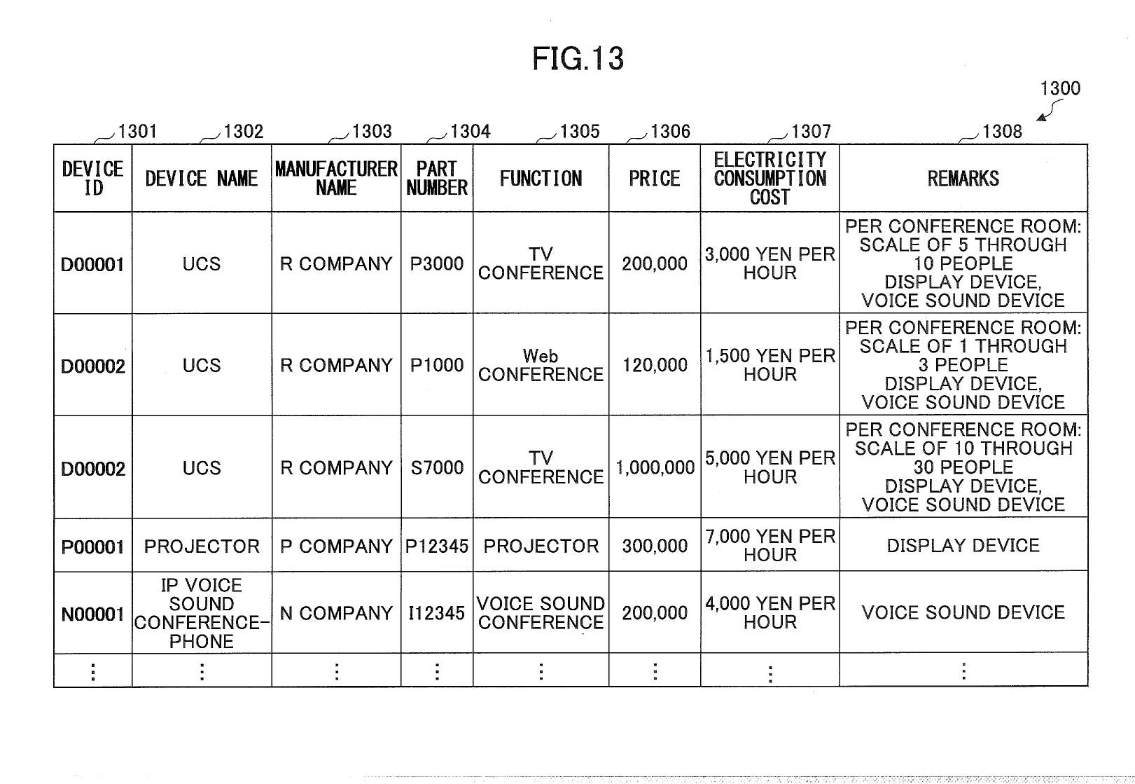

FIG. 13 illustrates an example of hardware management information according to an embodiment. Hardware management information 1300 includes information items of, for example, a device ID 1301, a device name 1302, a manufacturer name 1303, a part number 1304, a function 1305, a price 1306, an electricity consumption cost 1307, remarks 1308, etc.

The device ID 1301 is an identifier for identifying the hardware (device), and corresponds to, for example, the device ID 802 of FIG. 8. The device name 1302 is information indicating the name, etc., of the hardware. The manufacturer name 1303 is information indicating the manufacturer, etc., of the hardware. The part number 1304 is information indicating the part number, etc., of the hardware. The function 1305 is information indicating the function, the purpose, etc., of the hardware.

The price 1306 is information indicating the price of the hardware, for example, the recommended price, the delivery price, etc. The electricity consumption cost 1307 is information of the cost relevant to electricity (power), etc., that is consumed by the hardware. The remarks 1308 are information of a memorandum, a comment, a supplement, etc., relevant to the hardware.

The software management unit 309 of FIG. 3 manages information of the software used in the conference as software management information. For example, the participant of the conference is able to participate in the conference by installing a program, etc., of the conference in an information terminal such as a PC (Personal Computer), a tablet terminal, a smartphone, etc., without using a device (hardware) for the conference. For example, the software management unit 309 manages programs, etc., for the conference.

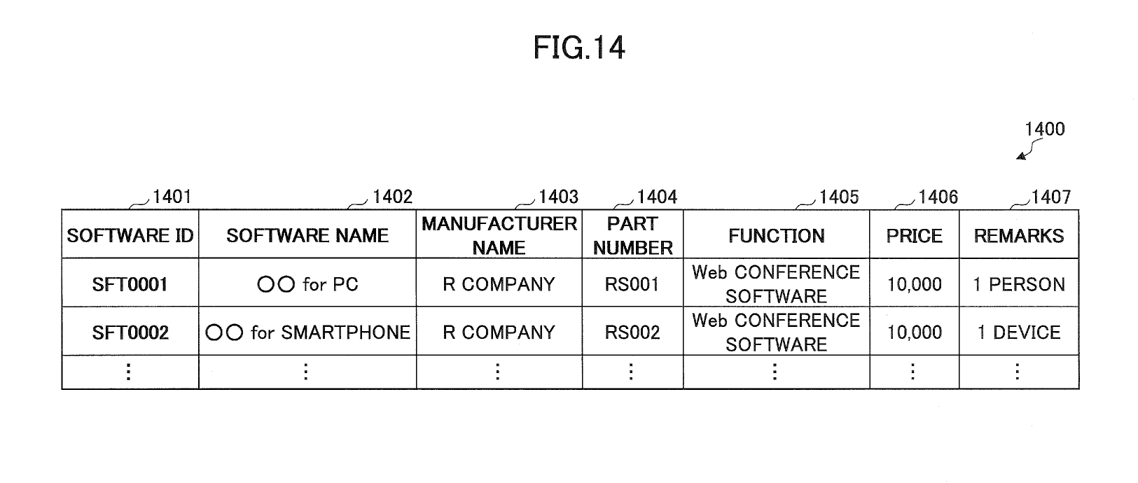

FIG. 14 illustrates an example of software management information according to an embodiment. Software management information 1400 includes information items of, for example, a software ID 1401, a software name 1402, a manufacturer name 1403, a part number 1404, a function 1405, a price 1406, remarks 1407, etc.

The software ID 1401 is an identifier for identifying the software. The software name 1402 is information indicating the name, etc., of the software. The manufacturer name 1403 is information indicating the manufacturer (for example, including the manufacturer, the developer, the vendor, etc.) of the software. The part number 1404 is information indicating the part number, etc., of the software. The function 1405 is information indicating the function, etc., of the software. The price 1406 is information indicating the price of the software, for example, the recommended price, the delivery price, etc. The remarks 1407 are information of a memorandum, a comment, a supplement, etc., relevant to the software.

As described above, the personnel management device 103 manages various kinds of information relevant to the hardware and software used in the conference, as illustrated FIGS. 13 and 14.

### <Functional Configuration of Equipment Information Management Device>

### First Embodiment

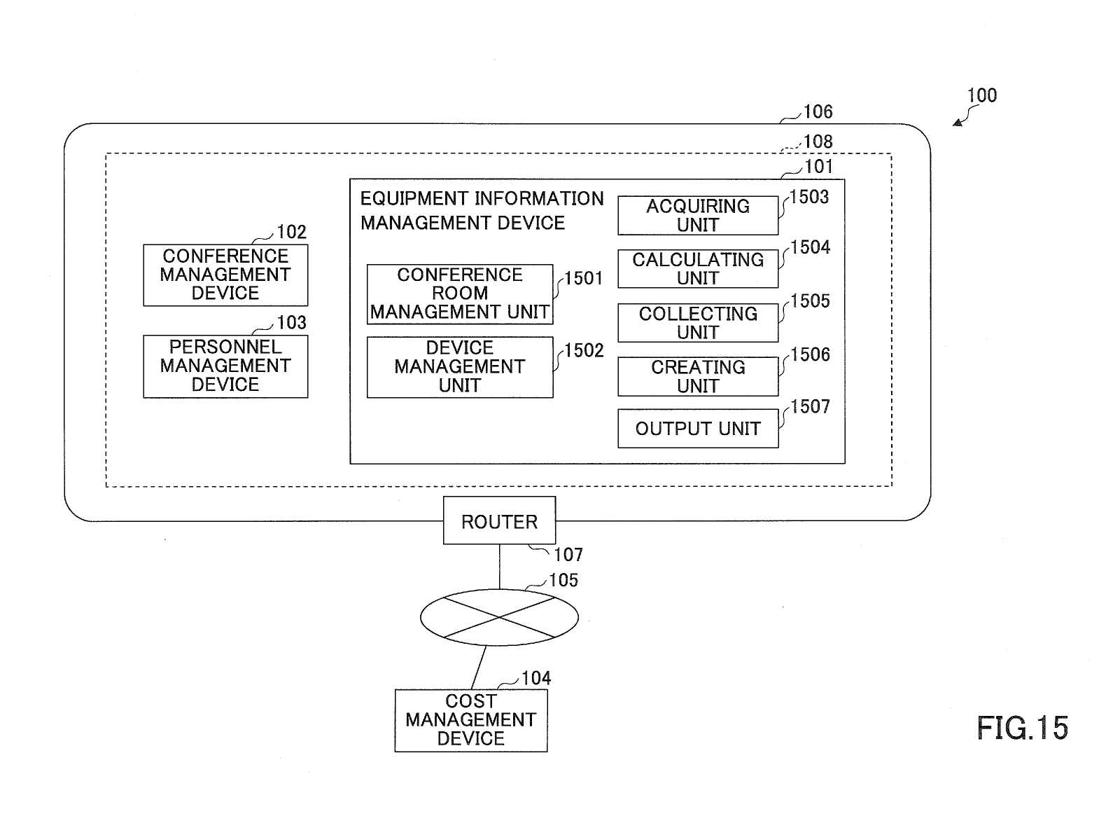

FIG. 15 illustrates a functional configuration of an equipment information management system 100 according to a first embodiment. An equipment information management device 101 according to the present embodiment includes a conference room management unit 1501, a device management unit 1502, an acquiring unit 1503, a calculating unit 1504, a collecting unit 1505, a creating unit 1506, an output unit 1507, etc. Note that the conference room management unit 1501, the device management unit 1502, the acquiring unit 1503, the calculating unit 1504, the collecting unit 1505, the creating unit 1506, and the output unit 1507 are realized by, for example, programs, etc., operating in the CPU 201, etc., in FIG. 2.

The conference room management unit 1501 of FIG. 15 manages conference room management information that is information relevant to a conference room, etc., used for the conference.

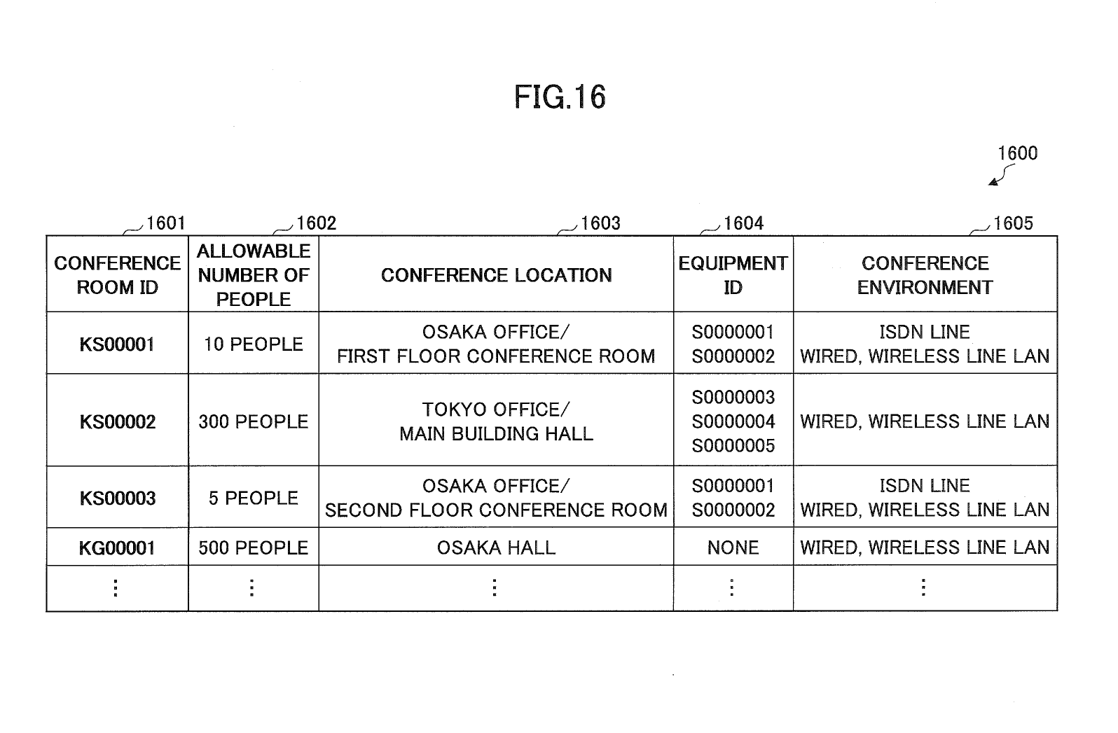

FIG. 16 illustrates an example of conference room management information according to an embodiment. Conference room management information 1600 includes information items of, for example, a conference room ID 1601, an allowable number of people 1602, a conference location 1603, an equipment ID 1604, a conference environment 1605, etc.

The conference room ID 1601 is an identifier for identifying the conference room. The allowable number of people 1602 is information indicating the maximum number of people, etc., that can use the conference room. The conference location 1603 is information indicating the location, etc., where the conference is held. The equipment ID 1604 is information relevant to the equipment provided in the conference room, for example, a conference table, a conference chair, etc. The conference environment 1605 is information relevant to the communication environment, etc., provided in the conference room.

The device management unit 1502 of FIG. 15 manages device management information that is information relevant to devices used for the conference.

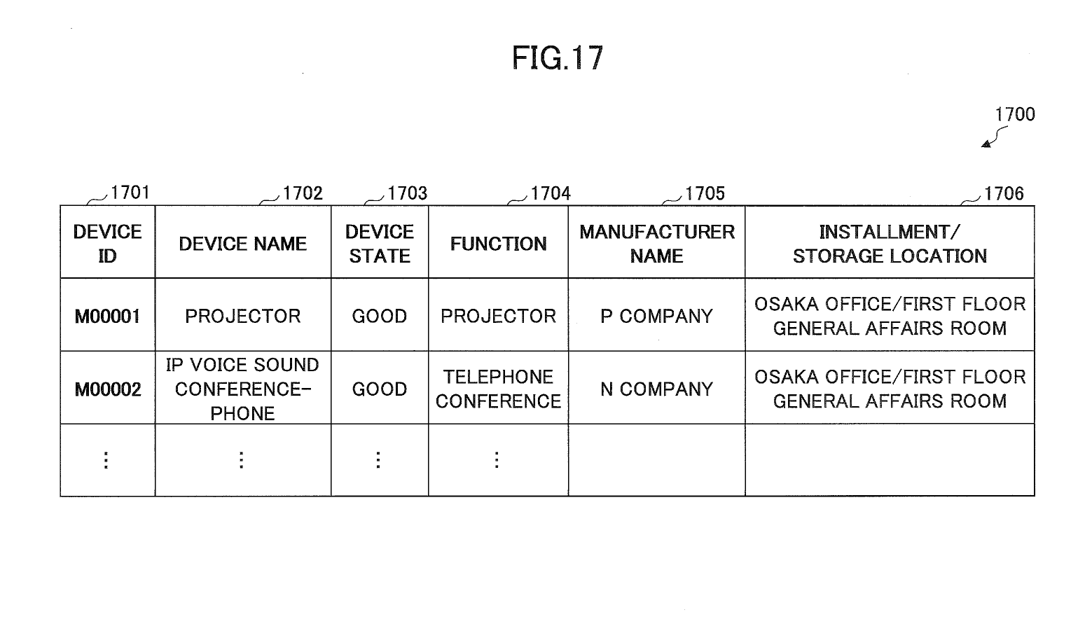

FIG. 17 illustrates an example of device management information according to an embodiment. Device management information 1700 includes information items of, for example, a device ID 1701, a device name 1702, a device state 1703, a function 1704, a manufacturer name 1705, an installment/storage location 1706, etc.

The device ID 1701 is an identifier for identifying the device. The device name 1702 is information indicating the name of the device. The device state 1703 is information indicating the state of the device, such as whether the device normally operates, etc. The function 1704 is information indicating the function, etc., of the device. The manufacturer name 1705 is information indicating the manufacturer, etc., of the device. The installment/storage location 1706 is information indicating the location, etc., where the device is installed or stored.

The acquiring unit 1503 of FIG. 15 acquires usage information relevant to a piece of equipment used among pieces of equipment that are management targets, from an external device managing the usage information of the pieces of equipment that are management targets. The usage information acquired by the acquiring unit 1503 includes, for example, the conference history information 700 managed by the conference management device 102; the employee management information 1000, the external management information 1100, and the accounting management information 1200 managed by the personnel management device 103, etc.

The calculating unit 1504 calculates the usage result value (for example, the cost, etc.) that indicates usage of (spent on using) the used equipment, based on the usage information acquired by the acquiring unit 1503. For example, the calculating unit 1504 uses the holding ID, etc., included in the target ID 1204 of the accounting management information 1200 of FIG. 12, to identify the conference and calculate the cost spent on the conference (usage of equipment, etc.).

For example, in FIG. 12, the cost spent on the conference whose holding ID is “K0001”, is the total of the three items having the accounting IDs 1201 of “B000001”, “B000002”, and “B000003”, and the cost spent on the conference is 265,000 yen. The calculating unit 1504 is able to calculate the costs spent on the conferences whose holding IDs are “K0002” and “K0003”, in a similar manner. Note that the accounting management information 1200 of FIG. 12 is merely one example. For example, the accounting management information 1200 may include other cost items such as the usage costs of equipment such as the conference room and devices, etc.

The collecting unit 1505 collects information of the equipment relevant to the used equipment. For example, the collecting unit 1505 identifies the scale of each conference (number of participants, used equipment, etc.), based on the usage information acquired by the acquiring unit 1503, and collects the information of equipment that can be alternatively used, from the cost management device 104, etc. Preferably, the collecting unit 1505 collects information of equipment that can be alternatively used in accordance with the scale of the conference, for example, information of alternative equipment of lower cost, based on the usage information acquired by the acquiring unit 1503.

Note that the information of equipment relevant to the used equipment, collected by the collecting unit 1505, may not only include equipment that can be alternatively used instead of the used equipment, but also equipment that is close to equipment that can be alternatively used, etc. For example, when the number of participants of a certain conference is 21 people, the information of equipment relevant to the used equipment may include equipment by which a conference of 20 people may be held, etc. Accordingly, for example, it is possible to let the host of the conference acknowledge that costs can be reduced by narrowing down the attendees when holding the next conference.

The creating unit 1506 creates a report (report information) including the usage result value (for example, the cost) calculated by the calculating unit 1504, and information of equipment relevant to the used equipment (equipment that can be alternatively used) collected by the collecting unit 1505. Preferably, the report created by the creating unit 1506 includes information relevant to the cost in the case where the conference is held by using the equipment that can be alternatively used. Furthermore, in this case, for example, the creating unit 1506 preferably calculates the expenses (cost) in consideration of participating in a conference from a remote location in accordance with the location of the attendee, etc.

As a specific example, when the conference is held in Osaka, the attendees form locations other than the Osaka office can participate in the conference by using the Internet and the PC of the attendee, such that the transportation cost is zero. At this time, the cost required for an attendee, who is from a location other than the Osaka office, to participate in the conference can be calculated by, for example, the price 1406 of FIG. 14 and/or the license fee, etc.

The output unit 1507 outputs a report (report information) created by the creating unit 1506. For example, the output unit 1507 may output the report (report information) created by the creating unit 1506 to another external device, or may output the report to a display unit, a storage unit, etc., of the equipment information management device 101. Preferably, the output unit 1507 outputs (reports) the report created by the creating unit 1506 to the user (for example, an administrator, the conference host), etc.

### <Process Flow>

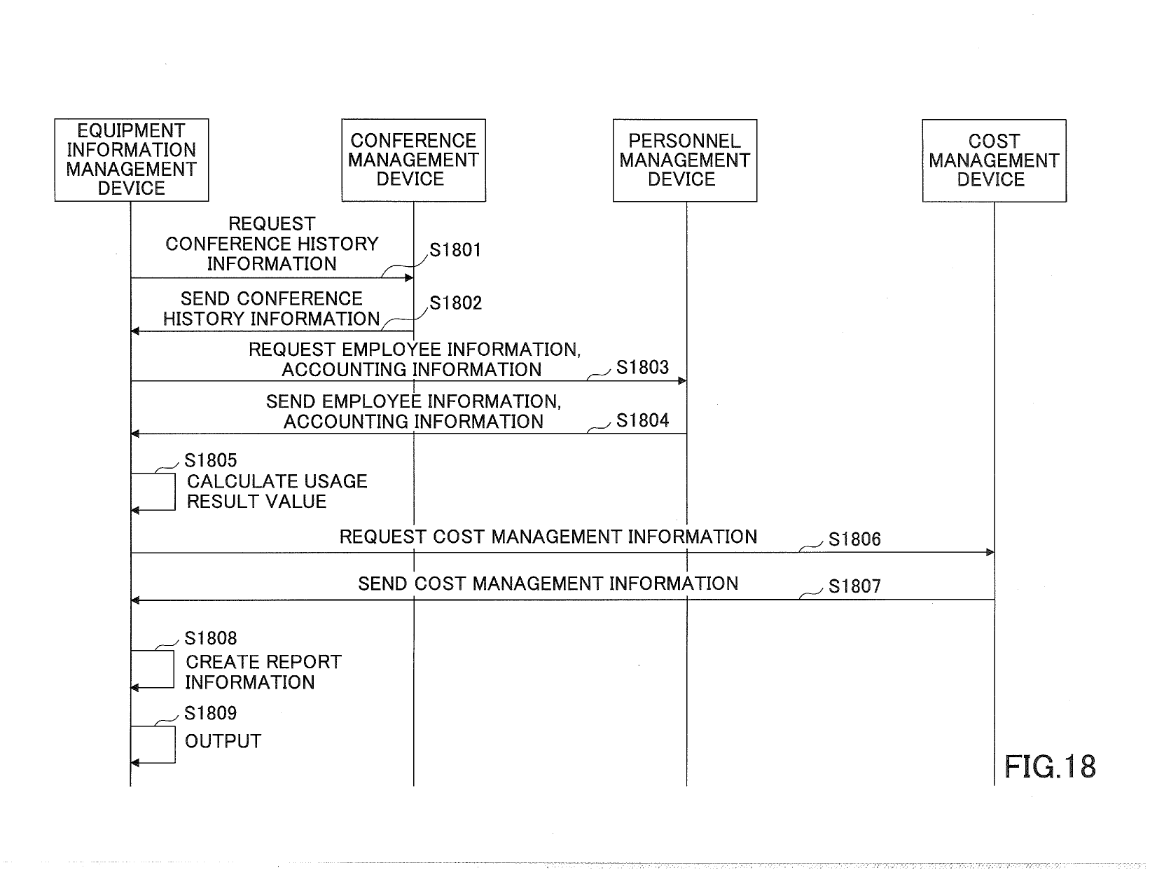

FIG. 18 is a sequence chart indicating an example of a process by the equipment information management system according to the first embodiment. The equipment information management device 101 executes the process of FIG. 18, for example, every time a predetermined period passes, or in response to a request from the administrator, etc.

In step S1801, the acquiring unit 1503 of the equipment information management device 101 requests the conference management device 102 to send the conference history information 700 of, for example, a conference that has been held within a predetermined period, etc.

In step S1802, in response to the request from the equipment information management device 101, the conference management device 102 sends the conference history information 700.

In step S1803, the acquiring unit 1503 requests the personnel management device 103 to send the employee management information 1000 of the participants, the external management information 1100, and the accounting management information 1200, etc., relevant to the held conference, based on the conference history information 700.

In step S1804, the personnel management device 103 sends the information of the employee management information 1000 of the participants, the external management information 1100, and the accounting management information 1200, etc., in response to the request from the equipment information management device 101.

In step S1805, the calculating unit 1504 of the equipment information management device 101 calculates the cost spent on the conference, for each conference held within the predetermined period, based on the information acquired by the acquiring unit 1503 (calculating procedure).

In step S1806, the collecting unit 1505 of the equipment information management device 101 requests the cost management device 104 to send information of equipment that can be alternatively used (cost management information), based on the scale of each conference held within the predetermined period (for example, the number of participants, equipment, etc.) (collecting procedure).

In step S1807, the cost management device 104 sends information of equipment that can be alternatively used (hardware management information 1300, software management information 1400, etc.), in response to the request from the equipment information management device 101.

In step S1808, for example, the creating unit 1506 of the equipment information management device 101 calculates the cost required for holding a conference by using the equipment that can be alternatively used acquired in step S1807, and creates a report (report information).

In step S1809, the output unit 1507 outputs the report created at step S1808 (output procedure).

As described above, according to the equipment information management system 100 according to the present embodiment, for every predetermined period, a report is provided, including the usage result including the cost, etc., spent on usage of the used equipment, and information of the equipment that can be alternatively used instead of the used equipment, for example, the cost required for using the alternative equipment, etc. Accordingly, it is easy to manage as to whether the equipment that is the management target, is efficiently used in accordance with the usage status.

### Second Embodiment

In the conventional conference system, the host (host of conference) has been able to freely select the equipment to be used in the conference. Therefore, for example, there have been cases where equipment such as a large conference room, etc., is used for a conference of a small number of participants, thus incurring wasteful cost. For example, the cost of the electricity, etc., of electricity used for the conference room, devices, etc., has increased.

In the present embodiment, a description is given of a process in which, for example, the equipment information management device 101 suggests appropriate equipment according to the contents, etc., of the conference to be held.

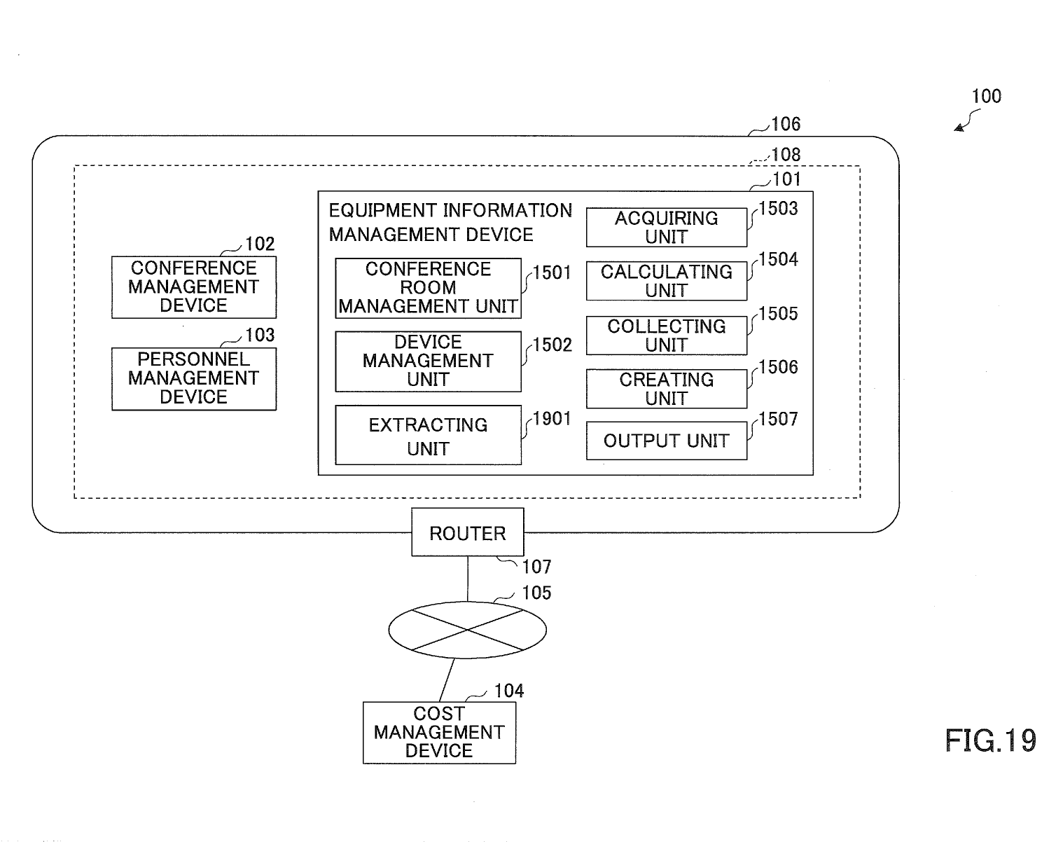

FIG. 19 illustrates a functional configuration of an equipment information management system according to a second embodiment. The equipment information management device 101 according to the present embodiment includes an extracting unit 1901, in addition to the configuration of the equipment information management device 101 according to the first embodiment. Note that elements other than the extracting unit 1901 are the same as those of the first embodiment, and therefore the difference between the first and second embodiments are mainly described herein.

The extracting unit 1901 extracts appropriate equipment (conference room, devices, etc.) in consideration of cost, etc., based on conference holding conditions (information of equipment scheduled to be used) acquired from the conference management device 102, etc., for example, information such as the number of participants and the location. Note that the extracting unit 1901 is realized by, for example, programs, etc., operating in the CPU 201, etc., in FIG. 2.

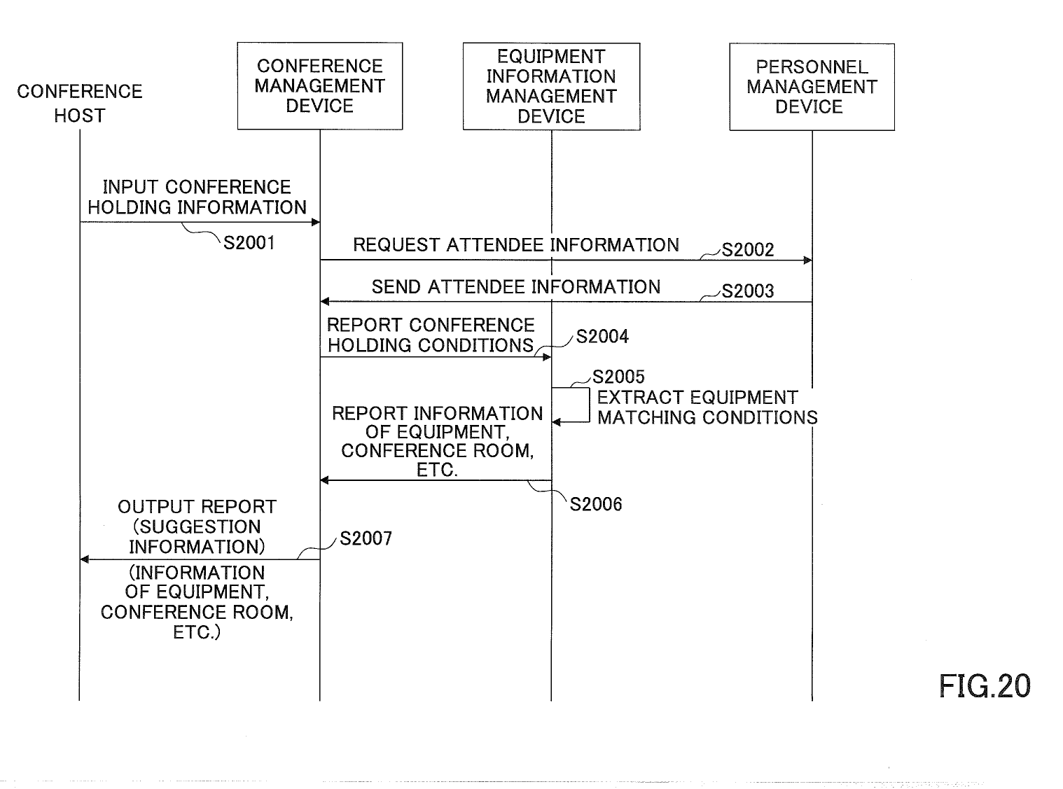

FIG. 20 is a sequence chart indicating an example of a process by the equipment information management system according to the second embodiment. FIG. 20 indicates a process in which, for example, when the host of the conference inputs conference holding information in the conference management device 102, equipment in accordance with the conference holding information is suggested to the host of the conference.

In step S2001, when the host of the conference inputs conference holding information in the conference management device 102, the conference management device 102 requests the personnel management device 103 to send information of attendees of the conference, for example, the employee management information 1000, the external management information 1100, etc. (step S2002). The personnel management device 103 that has received the request sends information of the attendees corresponding to the request, to the conference management device 102 (step S2003).

In step S2004, for example, the conference management device 102 reports the conference holding conditions including information of the attendees of the conference, etc., to the equipment information management device 101.

In step S2005, the extracting unit 1901 of the equipment information management device 101 extracts equipment matching the conference holding conditions (information of equipment scheduled to be used) received from the conference management device 102, in consideration of, for example, the cost, the number of people using the equipment, etc.

For example, when the number of attendees of the conference is three to four people, referring to the conference room management information 1600 of FIG. 16, the conference room ID 1601 “KS00003” is the first candidate, and the conference room ID 1601 “KS00001” is the second candidate. Furthermore, when the attendee is at a remote location, a conference room at a remote location is extracted according to need. Similarly, the devices to be used are extracted by the extracting unit 1901, according to for example, the device management information 1700, etc., of FIG. 17.

In step S2006, the equipment information management device 101 reports the information extracted by the extracting unit 1901, for example, of the equipment, the conference room, etc., to the conference management device 102.

In step S2007, the conference management device 102 outputs (for example, displays), to the conference host, the report (suggestion information) including the equipment, the conference room, etc., extracted at the equipment information management device 101. Accordingly, for example, the conference host is able to determine the conference holding information by using more appropriate equipment, based on the suggested information.

Furthermore, when creating the suggestion at step S2005, the equipment information management device 101 may create a report suggesting alternative equipment for reducing cost in accordance with the conference host, by using the hardware management information 1300, the software management information 1400, etc. of the cost management device 104.

For example, in step S2005, it is assumed that the extracting unit 1901 has suggested, as devices to be used in the conference, a projector having a device ID 1701 of “M00001” and an IP voice sound conference-phone having a device ID 1701 of “M00002”. At this time, for example, the extracting unit 1901 refers to the hardware management information 1300 managed by the cost management device 104, and suggests that the electricity cost per hour can be suppressed to 3000 yen, by using (implementing) the device ID 1301 “D00001”.

As described above, according to the equipment information management system 100 according to the present embodiment, information of appropriate information in accordance with the scale of the conference can be reported to the user (host of the conference, etc.). Accordingly, the equipment that is the management target can be efficiently used in accordance with the usage status.

According to one embodiment of the present invention, an equipment information management device, an equipment information management system, and an equipment information management method are provided, by which it is easy to manage as to whether the equipment that is the management target is efficiently used in accordance with the usage status.

The equipment information management device, the equipment information management system, and the equipment information management method are not limited to the specific embodiments described herein, and variations and modifications may be made without departing from the spirit and scope of the present invention.

The present application is based on and claims the benefit of priority of Japanese Priority Patent Application No. 2014-117297, filed on Jun. 6, 2014, the entire contents of which are hereby incorporated herein by reference.

What is claimed is:

1. An equipment information management device for managing information relating to equipment that is a management target, the equipment information management device comprising:
a calculating unit configured to calculate a usage result value that indicates usage of used equipment, based on usage information relating to the used equipment among the equipment that is the management target;
a collecting unit configured to collect information of equipment relating to the used equipment; and
an output unit configured to output report information including the calculated usage result value and the collected information of the relevant equipment.

2. The equipment information management device according to claim 1, wherein
the equipment relating to the used equipment includes alternative equipment that can be used instead of the used equipment.

3. The equipment information management device according to claim 2, wherein
the collecting unit collets information of the alternative equipment that can be used instead of the used equipment, based on the usage information.

4. The equipment information management device according to claim 1, further comprising:
a creating unit configured to create the report information, wherein
the report information to be created includes information of cost required for using the equipment relating to the used equipment.

5. The equipment information management device according to claim 1, further comprising:
an acquiring unit configured to acquire the usage information, from one or more external devices managing the usage information.

6. The equipment information management device according to claim 1, wherein
the collecting unit collects the information of the equipment relating to the used equipment, from an external device managing information of a plurality of pieces of equipment.

7. The equipment information management device according to claim 1, further comprising:
an extracting unit configured to extract equipment according to a usage schedule, based on information relating to the usage schedule of equipment.

8. The equipment information management device according to claim 7, wherein
the extracting unit extracts the equipment according to the usage schedule, from an external device managing information of a plurality of pieces of equipment.

9. An equipment information management system comprising an equipment information management device configured to manage information relating to equipment that is a management target; and an external device configured to manage information of a plurality of pieces of equipment including equipment different from the equipment that is the management target, wherein the equipment information management device includes
a calculating unit configured to calculate a usage result value that indicates usage of used equipment, based on usage information relating to the used equipment among the equipment that is the management target,
a collecting unit configured to collect, from the external device, information of equipment relating to the used equipment, and
an output unit configured to output report information including the calculated usage result value and the collected information of the relevant equipment.

10. An equipment information management method performed by an equipment information management device for managing information relating to equipment that is a management target, the equipment information management method comprising:
calculating a usage result value that indicates usage of used equipment, based on usage information relating to the used equipment among the equipment that is the management target;
collecting information of equipment relating to the used equipment; and
outputting report information including the calculated usage result value and the collected information of the relevant equipment.
